(19) United States
(12) Patent Application Publication
(10) Pub. No.: US 2007/0192117 A1
(43) Pub. Date: Aug. 16, 2007

(54) Layered freight security method

(75) Inventors: Ana Luisa Coronado Alvarez, Jalisco (MX); Edgar Gomez Lepe, Jalisco (MX); Ofelia Gonzalez Carrillo, Jalisco (MX); Juan Alberto Gonzalez Martinez, Jalisco (MX); Oliverio Miranda Iniguez, Jalisco (MX); Juan Carlos Polanco Campos, Jalisco (MX)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 11/352,045

(22) Filed: Feb. 10, 2006

(51) Int. Cl. G06Q 99/00

(52) U.S. Cl. 705/1

(57) ABSTRACT

A method, apparatus and computer usable program code for layered security of freight. Information for the mobile container carrier is verified within a database before allowing the mobile container into a facility in response to receiving a mobile container from a carrier. A thorough inspection of the mobile container is performed in response to verifying the information for the mobile container. The thorough inspection is verified and the mobile container is loaded with freight, in response to performing the thorough inspection. The mobile container is authorized to leave the facility in response to loading the mobile container. The mobile container is tracked as the mobile container is transported to a destination.

### BACKGROUND OF THE INVENTION

1. Field of the Invention

The present invention relates generally to data processing, and in particular to a method, apparatus, and computer usable program code for layered security of freight.

2. Description of the Related Art

Transportation of freight and logistics control are extremely important to many businesses. Freight shipping logistics are especially important to businesses that do business across international borders. For example, businesses ship millions of dollars of products from Mexico to the United States each day by trailer, boat, train and air. International transactions across the border need to be well organized so that shipments are safely and efficiently processed. Heightened border security due to drugs, smuggling, and business security has brought additional scrutiny to international transactions requiring additional care and control.

Many international transactions are organized individually based on the specified shipment of freight. Additional time and effort may be required to ensure that shipping standards and requirements are met during loading, transportation, and border crossing. Because of the many logistical issues, many businesses may avoid or limit international transactions because of unavailable or inadequate logistical infrastructure.

Additionally, many businesses incur unwanted expenses because they are unable to integrate shipping logistics which may include transportation provider records, security, global positioning system (GPS) tracking information, databases, and brokers. Due to increased security issues and transportation fines and penalties, liability for improper logistics has grown significantly. As a result, businesses that perform international transactions need to be able to effectively manage transportation logistics at many different levels using standardized processes.

### BRIEF SUMMARY OF THE INVENTION

The aspects of the present invention provide a method, apparatus, and computer usable program code for layered security of freight. Information for the mobile container carrier is verified within a database before allowing the mobile container into a facility in response to receiving a mobile container from a carrier. A thorough inspection of the mobile container is performed in response to verifying the information for the mobile container. The thorough inspection is verified and the mobile container is loaded with freight, in response to performing the thorough inspection. The mobile container is authorized to leave the facility in response to loading the mobile container. The mobile container is tracked as the mobile container is transported to a destination.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is pictorial representation of a data processing system in which the aspects of the present invention may be implemented;

FIG. 2 is a block diagram of a data processing system in which aspects of the present invention may be implemented;

FIG. 3 is a pictorial map of locations used for layered security of land freight in accordance with an illustrative embodiment of the present invention;

FIG. 4 is a flowchart of a process for a layered freight security system in accordance with an illustrative embodiment of the present invention;

FIG. 5 is an exemplary layer one check list in accordance with an illustrative embodiment of the present invention;

FIG. 6 is an exemplary layer three check list in accordance with an illustrative embodiment of the present invention;

FIG. 7 is an exemplary layer four check list in accordance with an illustrative embodiment of the present invention;

FIG. 8 is a flowchart of a process for a first layer of a layered security system in accordance with an illustrative embodiment of the present invention;

FIG. 9 is a flowchart of a process for a second and third layer of a layered security system in accordance with an illustrative embodiment of the present invention;

FIG. 10 is a flowchart of a process for a fourth layer of a layered security system in accordance with an illustrative embodiment of the present invention;

FIG. 11 is a flowchart of a process for a fifth, sixth and seventh layer of a layered security system in accordance with an illustrative embodiment of the present invention;

FIG. 12 is a flowchart of a process for an eighth layer of a layered security system in accordance with an illustrative embodiment of the present invention;

FIG. 13 is a diagram of a graphical user interface for a layered freight security program in accordance with an illustrative embodiment of the present invention; and

FIGS. 14A-14G are diagrams of a graphical user interface for a trailer database in accordance with an illustrative embodiment of the present invention.

### DETAILED DESCRIPTION OF THE INVENTION

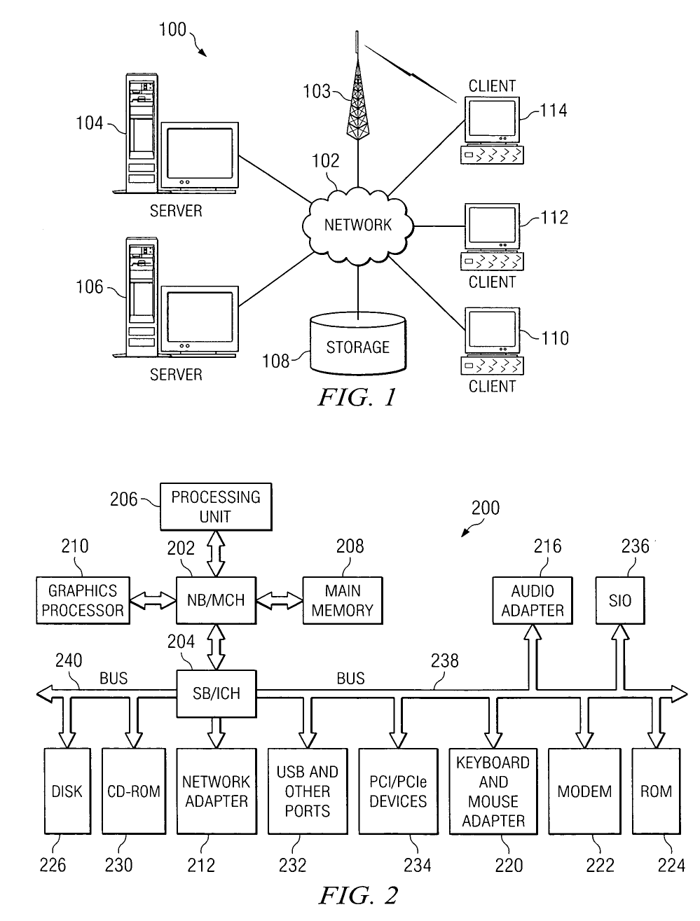

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables. In one example, wireless access link 103 is an example of a connection within network 102 that allows for any number of computing devices to connect with network 102 wirelessly.

In the depicted example, server 104 and server 106 connect to network 102 along with storage unit 108. In addition, clients 110, 112, and 114 connect to network 102. These clients 110, 112, and 114 may be, for example, personal computers, network computers, or other computing devices. In the depicted example, server 104 provides data, such as boot files, operating system images, and applications to clients 110, 112, and 114. Clients 110, 112, and 114 are clients to server 104 in this example. Clients 110, 112, and 114 may be connected to network 102 by land lines or wirelessly through wireless access link 103. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data using a cable or wireless connection, such as modem 222 or network adapter 212 of FIG. 2. The communication unit may also be a wireless adapter communicating with a wireless access link. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a mobile computing device such as a tablet computer, laptop computer, or telephone device in addition to taking the form of a PDA.

The aspects of the present invention provide a method, apparatus, and computer usable program code for layered security of freight. Freight is cargo, goods, products or a load that is being shipped from one location to another. Freight may be shipped in any number of ways, including for example, semi-trailer, train, airplane, boat, or other form of shipment. In particular, the aspects of the present invention provide architecture for organizing freight logistics with entities, such as a carrier, business logistics personnel, business security personnel, and border security. In addition, information from each party to the transaction including records, security, global positioning system (GPS) tracking information, and databases may be integrated for easier information storage and retrieval using the different aspects of the present invention. Embodiments of the method include using a mobile container. In examples referenced herein, the mobile container is a semi-trailer or trailer loaded with freight. In other examples, the mobile container may be a crate, liquid container, freight container, semi-trailer, or other receptacle for storing and transporting freight that may be loaded onto a semi-trailer, train, boat, airplane or other transportation device.

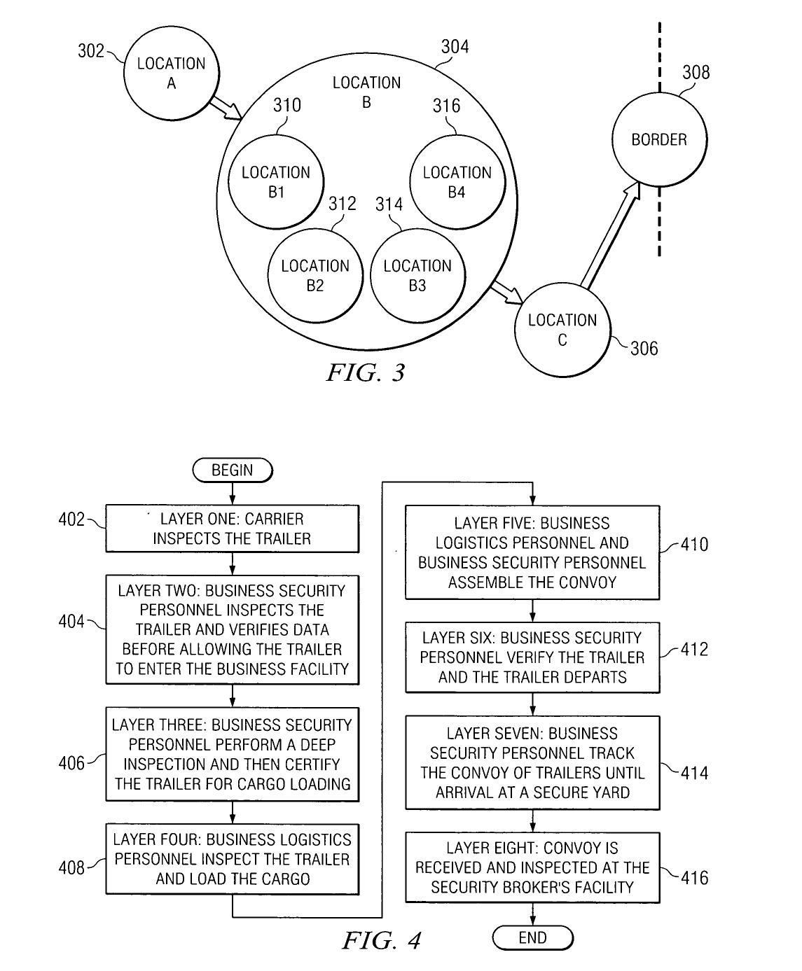

FIG. 3 is a pictorial map of locations used for layered security of land freight in accordance with an illustrative embodiment of the present invention. Embodiments of the present invention may be applied to a land freight security method or process. The processes for the various levels for the layered security may be performed in different locations as illustrated in FIG. 3. These locations include location A 302, location B 304, location C 306, and border 308. Operations performed at location A 302 may be performed by a carrier. Operations performed at location B 304 may be performed by business security personnel and business logistics personnel. Operations performed at location C 306 may be performed by a security broker. The destination of the freight may be any number of locations including intermediary locations. For example, the destination of the freight may be an airport, train depot, shipping dock, or customs. The operations performed at each location are done preparatory to the freight crossing border 308 to a final destination. The final destination may be the facility of the client or party receiving the freight.

Computing devices such as client 110, 112, and 114 of FIG. 1 may be used from location A 302, location B 304, and location C 306 to access a trailer database which may be accessible over a network and stored in a storage unit, such as network 102 and storage 108 of FIG. 1 respectively. In one embodiment, personnel at each location may use a computing device to wirelessly access, read, and update information to the trailer database. Other information about the mobile container may be similarly accessed and updated. For example, a wireless computing device may include a scanner that may be used to scan information such as invoice and docket numbers, bar codes, and seal numbers. Business personnel may be required to update and verify information with the trailer database before they receive an indicator authorizing the trailer to move to the next layer.

Location B 304 may include various other sub-locations including: location B1 310, location B2 312, location B3 314, and location B4 316. Location A 302 is the carrier site or carrier facility. The carrier refers to the entity hired by the business used to haul goods and products in the form of freight. The entity may be for example, a transportation, shipping, air freight, or trucking company. In these examples, the carrier may be hired by the business to transport computer servers from Mexico to the United States. Location B 304 is the business facility. The business facility is a business location including buildings, facilities, docks, storage, and personnel used to search, secure, inspect, and load the trailer with freight.

Location B1 310 is the business gate at which the trailer is preliminarily searched by business security personnel before the trailer is allowed into the business facility of location B 304. Location B2 312 is the trailer inspection yard where the trailer is further searched by business security personnel and stored as needed. Location B3 314 is the loading dock where the trailer is loaded with the product to be shipped by business logistics personnel. Location B4 316 is the main exit to the business facility of location B 304. Location C 306 is the secure yard of a security broker. Location C may be the destination of the trailer and may be further sent to a final destination.

The security broker prepares all necessary documentation used to effectuate the international transaction including border crossing papers, manifests and other import and export documentation. Border 308 is the international border between the countries in question. For example, border 308 may be the borderline between Mexico and the United States of America. In another example, border 308 may be the border between the Canada and United States.

FIG. 4 is a flowchart of a process for a layered freight security system in accordance with an illustrative embodiment of the present invention. Embodiments of the present invention may be applied to an eight layer asset security process. FIG. 4 illustrates exemplary steps that may be used to protect freight as the freight is prepared for an international border crossing.

The process begins when a business requests a trailer from the carrier. In layer one, the carrier inspects the trailer (step 402). The carrier inspects and measures the trailer inside and out to verify that the trailer is secure, functional, and clean. The carrier uses a layer one check list provided by the business to verify the driver's name, date, hour, internal and external dimensions, observations, recent repairs, comments, and the inspector's signatures. The check list ensures that the trailer does not have any hidden compartments and that the trailer is safe for transportation of freight.

When the check list is completed, the carrier places a seal on the trailer before the trailer leaves the carrier site. Information from the check list and other trailer data is then loaded into a trailer database. The trailer database is a database that may be accessible by the carrier, business security personnel, business logistics personnel, and security broker for verifying trailer data throughout the layered security process. The business personnel control access to the trailer database including specifying the parties that may upload or download information from the trailer database. For example, access to the trailer database may be limited for the carrier and security broker so that the business may ensure that all information in the database is correct and accurate. For example, step 402 may be performed by the carrier at a carrier site such as location A 302 of FIG. 3 by submitting trailer information to business security personnel that is approved before the trailer information is entered into the trailer database.

In layer two, the business security personnel inspect the trailer and verify data before the trailer is allowed to enter the business facility (step 404). For example, when the trailer driver arrives, the driver submits an official picture identification and the layer one check list. An official picture identification is a government or business certified identification issued by the indicated government or business authority including a picture. In some cases, the driver may be required to show both a government certified picture identification and building certified picture identification. If the trailer passes a physical inspection and the layer one check list is complete, the driver receives an internal traffic pass. The business security personnel then update the trailer database and grant access to the business facility. In one example, business security personnel may enter information into the trailer database and once the information is verified, business security may receive an entry indicator authorizing the trailer to enter the business facility. Step 404 may be performed at a business gate such as location B1 310 of FIG. 3.

In layer three, business security personnel perform a thorough inspection and then certify the trailer for cargo loading (step 406). A thorough inspection is a systematic inspection of the trailer structure and trailer functional components. Functional components may include, for example, brakes, lights, hydraulic connections, wheels, rims, and tires. The thorough inspection is conducted in accordance with a policy. The policy establishes that the trailer must be structurally and functionally suited for the purpose of transporting freight safely and securely. For example, the walls, floor, ceiling and undercarriage of the trailer are searched for hidden compartments. Before the trailer is allowed to enter the trailer inspection yard, the driver must present the internal traffic pass. Once the trailer is inside the trailer inspection yard, the truck may leave the business facility. The trailer is monitored by closed circuit television and/or a guard while in the trailer inspection yard. Business security personnel perform a thorough inspection as required by a layer three check list. For example, the layer three check list may require internal and external measurements, pat downs, inspection of internal and external walls, ceiling, floor, doors, recent repairs, and examination of strange odors and suspect packages or products.

Once the thorough inspection is completed, the business security personnel seal the trailer with a seal, register the seal serial number, and verify and enter the data from a layer three check list into the trailer database. In one example, business security personnel may enter information into the trailer database and once the information is verified, business security may receive a load indicator authorizing the trailer to be loaded. Step 406 may be performed at a trailer inspection yard such as location B2 312 of FIG. 3.

In layer four, business logistics personnel inspect the trailer and load the cargo (step 408). Before loading the trailer with the designated cargo, business logistics personnel inspect the trailer according to a layer four check list to make sure that the trailer complies with business defined requirements. For example, business logistics personnel may inspect the seal previously attached during inspection at layer three. The seal is verified in the layer three check list and also in the trailer database. Once the layer four check list is completed, business logistics personnel update the trailer database and load the cargo into the trailer.

When the trailer is loaded, the door(s) is sealed with a seal and certificate. For example, the seal may be an international standard organization tamper proof seal 17712. Additionally, global logistics may take pictures of the trailer as loaded for further documentation. In the examples, the pictures are digital photographs. These photographs may include seals, license plates, trailer identification number, condition and physical appearance of all aspects of the trailer, and the driver. Step 408 may be performed at a loading dock such as location B3 314 of FIG. 3.

In layer five, business logistics personnel and business security personnel assemble the convoy of trailers that will be crossing the international border (step 410). Business security personnel may take additional photographs of the assembled trailer and convoy to verify the condition of the trailer at departure. Step 410 may be performed at a main exit such as B4 316 of FIG. 3.

In layer six, business security personnel verify the trailer and the trailer departs (step 412). Step 412 may be performed at a main exit such as location B4 316 of FIG. 3. In one example, business security personnel may enter exit information into the trailer database and once the information is verified, business security may receive an exit indicator authorizing the trailer to exit the business facility.

In layer seven, business security personnel tracks the convoy of trailers until they arrive at the secure yard (step 414). All trailers are escorted by private security. Additionally, the private security checks in periodically using cell phones or other communications. The convoy is also equipped with global positioning system technology so that the convoy's location may be ascertained by business security personnel at any time. Step 414 may be performed between the main exit and secure yard such as location B4 316 and location C 316 of FIG. 3, respectively.

In layer eight, the security broker receives the convoy of trailers, verifies the documentation and physical condition of the trailers (step 416). The security broker verifies that the trailers condition has not changed and prepares all necessary documentation for the international border crossing. Step 416 may be performed at a secure yard such as location C 306 of FIG. 3. Business security personnel may further track the freight to the final destination in order to confirm arrival.

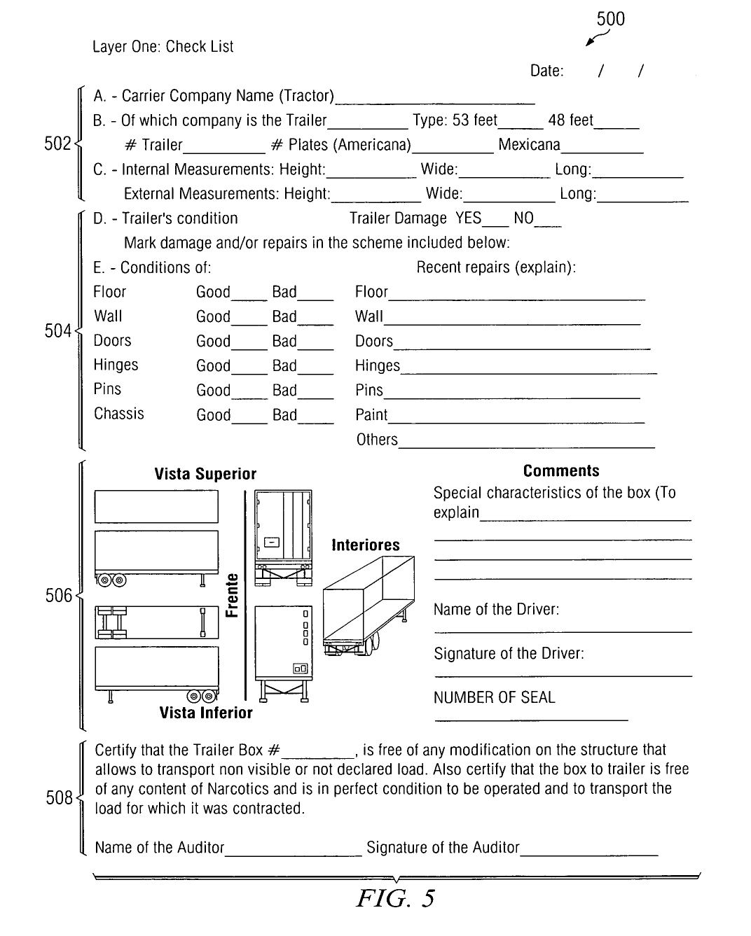

FIG. 5 is an exemplary layer one check list in accordance with an illustrative embodiment of the present invention. Layer one check list 500 is a check list that may be completed by the carrier and verified by business security personnel in steps of a layered security process such as steps 402 and 404 of FIG. 4. Layer one check list 500 may be a document, electronic document, or other computer usable medium that may be automatically updated to trailer database. For example, the carrier may use a laptop computer to complete layer one check list while physically viewing the trailer and send the completed file or document to the business electronically upon completion. Layer one check list 500 may be filled out in any language. For example, when cargo is shipped from Mexico to the United States, the carrier and business security personnel may be more comfortable completing layer one check list 500 in Spanish.

Section 502 allows a user to enter information such as carrier name, trailer type, trailer plates, and internal and external measurements used to identify the specific trailer. Section 502 may allow the trailer to be identified at any time during the layered security process.

Section 504 allows a user to enter information indicating the condition of the trailer. For example, section 504 may allow a user to indicate condition and recent repairs particularly on the floor, walls, doors, hinges, pins, and paint. Section 506 includes a graphical representation of all aspects of the trailer that allow a user to further indicate anomalies and make comments as needed. Additionally, the driver's name, signature and a seal number may be entered for documentation. Section 508 allows an auditor to certify the information included on layer one check list 500.

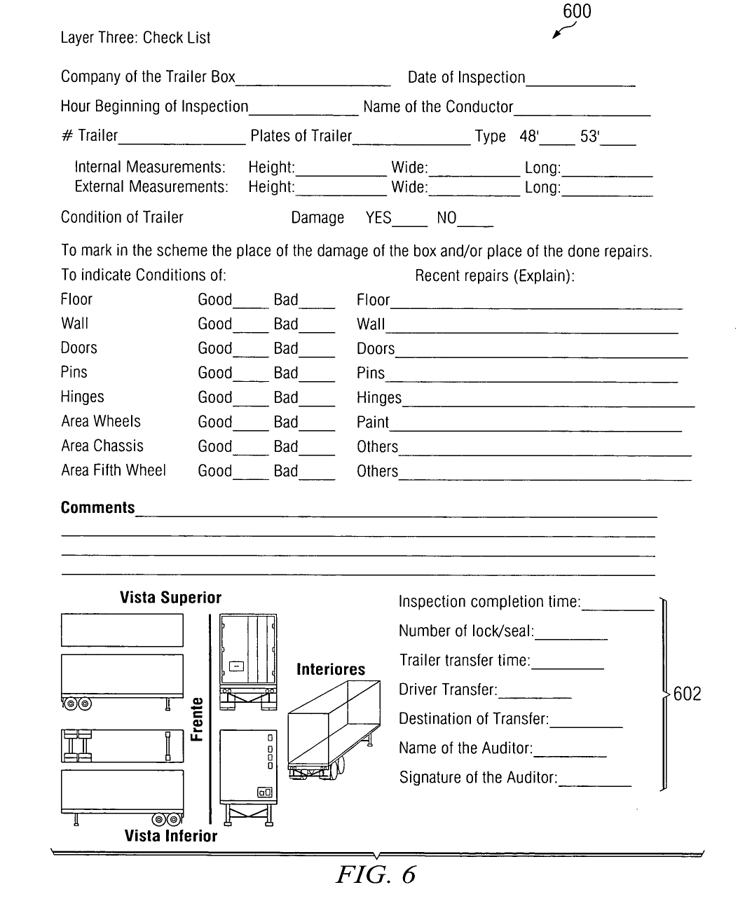

FIG. 6 is an exemplary layer three check list in accordance with an illustrative embodiment of the present invention. Layer three check list 600 may be completed by business security personnel and verified by business logistics personnel in steps of a layered security process such as steps 406 and 408 of FIG. 4. Layer three check list 600 includes information such as section 502, section 504, and section 506 of FIG. 5. Additionally, section 602 allows a user to enter additional information certifying the time of the thorough inspection. For example, the user may enter the inspection completion time, number of lock/seal, trailer transfer time, driver transfer, destination of transfer, name of auditor, and signature of auditor among other information.

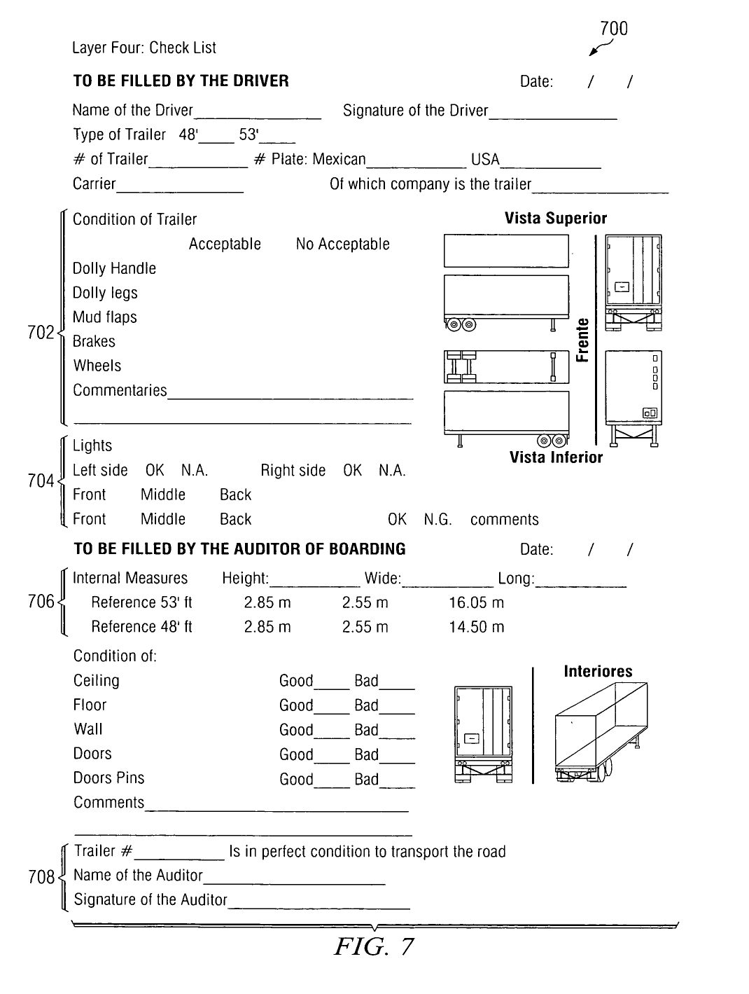

FIG. 7 is an exemplary layer four check list in accordance with an illustrative embodiment of the present invention. Layer four check list 700 includes information such as section 502, section 504, and section 506 of FIG. 5. Layer four check list 700 may be completed by the logistics in a step of a layered security process such as step 408 of FIG. 4. Layer four check list 700 may also include section 702 which allows a user to specify the condition of trailer components which may include a dolly, mud flaps, brakes, and wheels. In one embodiment, the user may indicate that the components are acceptable or not acceptable. Section 704 allows a user to specify the condition of the trailer lights positioned around the periphery of the trailer. Section 706 allows a user to specify the internal measurements of the trailer as measured to complete layer four check list 700. Section 708 allows a user to certify that the trailer is in condition to transport the specified freight as well as recording the name and signature of the auditor completing layer four check list 700.

FIG. 8 is a flowchart of a process for a first layer of a layered security system in accordance with an illustrative embodiment of the present invention. The process depicted in FIG. 8 is a more detailed description of step 402 in FIG. 4. The steps of FIG. 8 may be performed by the carrier at a carrier site such as location A 302 of FIG. 3. The process begins when the carrier receives a request (step 802). This request may be received from a business for a trailer. The request may be received by using different communications mechanism, such as electronic mail, phone, in person, or by other communication from the business to the carrier.

The carrier inspects and measures the trailer (step 804). The carrier may inspect and measure the internal and external length, height, and width. The carrier may also inspect the trailer walls, ceiling, floor, front, top, undercarriage, chassis, suspension, air brake chambers, wheels, doors, and other aspects of the trailer. The carrier may also examine recent repairs and suspect packages or products included with the trailer.

The carrier fills out the layer one check list (step 806). The layer one check list may be a check list such as layer one check list 500 of FIG. 5. The carrier may use the inspection and measurement of step 804 to complete the layer one check list of step 806. Additionally, the carrier may include information regarding the date, trailer license plate numbers, trailer identification numbers, trailer name, trailer standard size, comments, and the truck driver's name.

The carrier determines whether the layer one check list requirements are met (step 808). The determination of step 808 indicates whether the trailer is suitable for the intended purpose of transporting freight. If the requirements are not met, the trailer is not sent to the business (step 810) with the process terminating thereafter. The trailer is unsuitable for the transporting freight and is rejected before being sent to the business.

If the layer one check list requirements are met in step 808, the carrier seals the empty trailer (step 812). The seal may be any form of identifiable seal that ensures that the trailer remains closed during transportation between the carrier's site and the business facility. The seal is tamper proof ensuring that the seal cannot be removed without showing visible signs of tampering or removal. Next, the carrier loads the trailer information into the trailer database (step 814). For example, the carrier may include the layer one check list or information from the layer one check list, seal information, and digital photographs of the trailer. In another embodiment, the carrier may send the information to the business and the business will load the trailer information into the trailer database. The carrier may then send the trailer to a business facility.

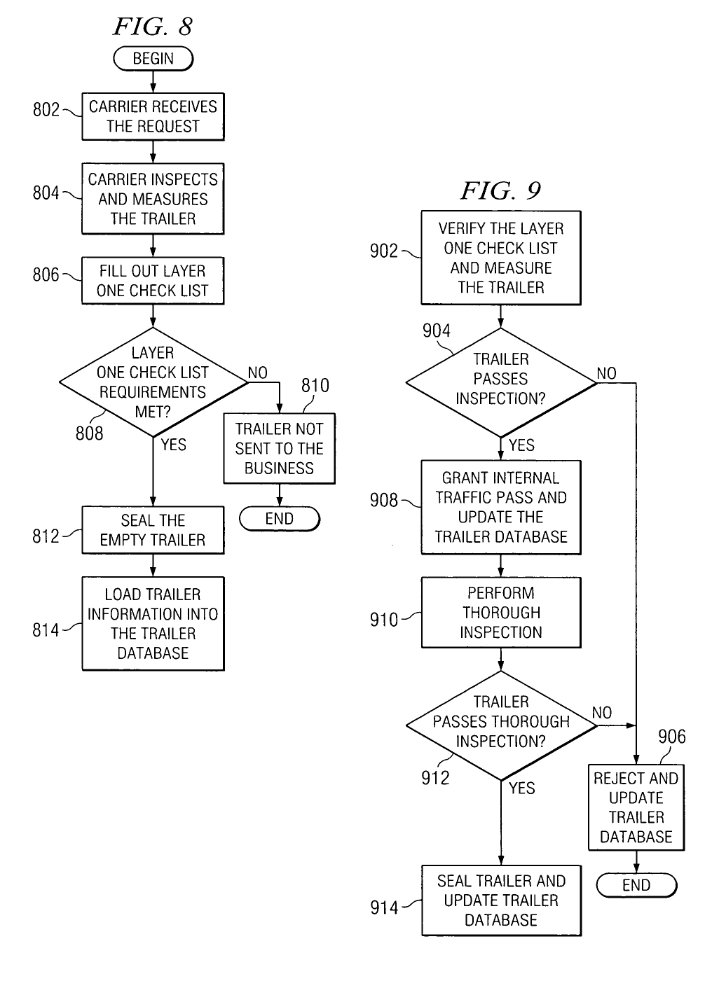

FIG. 9 is a flowchart of a process for a second and third layer of a layered security system in accordance with an illustrative embodiment of the present invention. The process depicted in FIG. 9 is a more detailed description of step 404 and 406 in FIG. 4. The steps of FIG. 9 may be performed by business security personnel at a business gate and trailer inspection yard such as location B1 310 and location B2 312 of FIG. 3, respectively.

The process begins in layer two as business security personnel verify information from the layer one check list, physically inspect, and measure the trailer (step 902). Business security personnel compare the information in the trailer database with the trailer physically. Layer one check list may be a check list such as layer one check list 500 of FIG. 5. Step 902 is performed at the business gate such as location B1 310 of FIG. 3 before the trailer is allowed into the business facility. Business security personnel may verify the seal placed on the trailer by the carrier before removing the seal to inspect and measure the trailer.

Next, business security personnel determine if the trailer passes inspection (step 904). The trailer may pass inspection if the documentation provided is correct, the trailer database describes the trailer accurately, and the measurements of the trailer are the same. If the trailer does not pass inspection, business security personnel reject the trailer and update the trailer database (step 906) with the process terminating thereafter. By updating the trailer database, business security personnel may record the incident for the future. For example, business security personnel may flag the carrier for failing an inspection, indicate that the trailer is suspect, and further document the failure of the trailer to pass inspection.

If the trailer passes inspection in step 904, business security personnel grants an internal traffic pass and updates the trailer database (step 908). Business security personnel may also place a new seal on the trailer verifying that the trailer has been searched and sealing the trailer openings. The trailer is moved from the main gate to the trailer inspection yard such as location B2 312 of FIG. 3.

Next the process proceeds to layer three, business security personnel perform a thorough inspection (step 910). The thorough inspection is a rigorous inspection of the interior and exterior of the trailer to ensure that the trailer does not include any prohibited items, defective structure or components, and is otherwise suited for transporting freight. During thorough inspection business security personnel verify the layer one check list completed by the carrier. Additionally, business security completes a layer three check list such as layer three check list 600 of FIG. 6. During thorough inspection, business security personnel review general information about the trailer including company name of the trailer, inspection date, inspection time, license plate, inspector name, and trailer type. In addition, business security personnel verifies all internal and external measurements and notes from the previous inspection.

Business security personnel further inspect the structure of the trailer including the floor and wall, orifices, rivets, and seams. Business security personnel look for any trailer abnormalities, scratches, dents, new panels, false bottoms, and other anomalies. Business security personnel may use mirrors, auditory and visual tests, or other physical inspection methods to perform the inspection. In one example, business security personnel may strike the walls to determine if the walls contain any foreign articles. Business security personnel also review pins, hinges, and door functionality. The undercarriage of the trailer is also inspected including tires, rimes, brakes, axles, support structure, and hoses to ensure each component is secure and is not being used to hide anything.

Next, business security personnel determine whether the trailer passes the thorough inspection (step 912). If the trailer does not pass the inspection according to layer three check list, the business security personnel reject the trailer and update the trailer database (step 906). If the trailer passes the inspection of step 912, business security personnel seal the trailer and update the trailer database (step 914). The trailer is then ready to be sent to the loading dock.

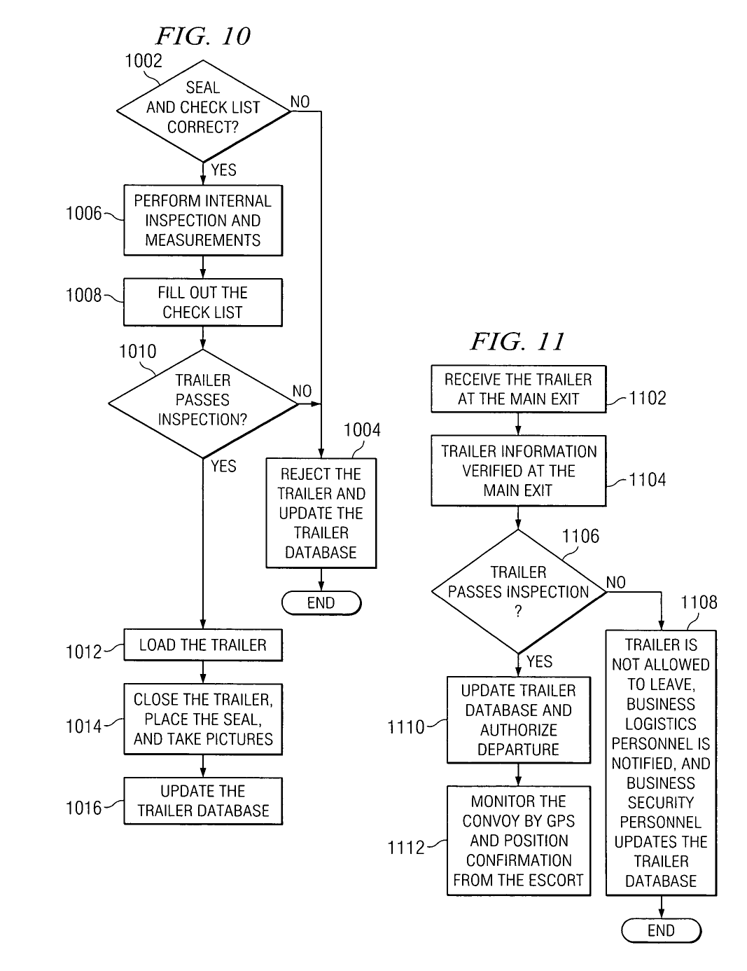

FIG. 10 is a flowchart of a process for a fourth layer of a layered security system in accordance with an illustrative embodiment of the present invention. The process depicted in FIG. 10 is a more detailed description of step 408 in FIG. 4. The steps of FIG. 10 may be performed by business logistics personnel at a loading dock such as location B3 314 of FIG. 3. The process begins with logistics determining if the seal and layer three check list are correct (step 1002). Business logistics personnel may use information from the trailer database to verify the seal and check list. A copy of the check list may also be sealed inside the trailer and may be verified by business logistics personnel. If the seal and check list are not correct, business logistics personnel reject the trailer and update the trailer database (step 1004) with the process terminating thereafter. Business logistics personnel may also physically remove the trailer from the business facility.

If the seal and check list are correct in step 1002, business logistics personnel perform an internal inspection and measurements (step 1006). The internal inspection and measurements may be performed according to a layer four check list such as layer four check list 700 of FIG. 7. Business logistics personnel fill out the check list (step 1008). Next, business logistics personnel determine if the trailer passes inspection (step 1010). The inspection is based on the layer four check list. If the trailer does not pass inspection, business logistics rejects the trailer and updates the trailer database (step 1004).

If the trailer passes the inspection in step 1010, business logistics personnel loads the trailer (step 1012). The freight is loaded into the trailer so that it will be secure during transportation. Next, business logistics personnel close the trailer, place the seal and take photographs (step 1014). The seal is preferably a seal certified by the international standards organization (ISO) such as ISO 17712. Each opening of the trailer may be sealed to ensure that the integrity of the cargo is not violated without an indication that the seal has been broken, damaged, replaced, or altered.

Business logistics personnel may request a truck and driver from the carrier at this point. The carrier may be required to submit identifying information about the truck and driver to be updated in the trailer database.

The seals may be kept placed in a lock for security until used. Additionally, only authorized personnel may have access to the seals and information such as seal number, and quantity of seals. Authorization to use a seal including the time and date of authorization may also be recorded by business logistics personnel. For example, data regarding the seals may be maintained in a database such as trailer database.

Photographs are taken of the trailer when closed and as the seal is placed on the trailer. The photographs verify the condition of the trailer, seal position, seal number and other information that may be used to verify that the cargo is protected and secure. Next, business logistics personnel update the trailer database (step 1016). The trailer database is updated with the layer four check list. The identification number of each seal and the inspector's name are also documented. In one embodiment, the digital pictures are taken during each level of the layered security process and are uploaded to the trailer database.

FIG. 11 is a flowchart of a process for a fifth, sixth and seventh layer of a layered security system in accordance with an illustrative embodiment of the present invention. The process depicted in FIG. 11 is a more detailed description of steps 410, 412, and 414 in FIG. 4. The steps of FIG. 11 may be performed by business security personnel and business logistics personnel at a main exit and secure yard such as location B4 316 of FIG. 3.

The process begins in layer five as business security personnel receive the trailer at the main exit (step 1102). The trailer information is verified at the main exit and the convoy and escort are prepared (step 1104). A convoy refers to a group of one or more trailers being transported together. The trailer information may include the seal, plates, driver, internal traffic pass, and one or more check lists from the different security layers. The trailer information stored in the trailer database may be compared against the trailer physically. Preparations may include following a trailer dispatch procedure. The procedure may include the carrier providing proof of receipt for the freight and business security personnel signing dispatch documents. The trailer database may be updated with the documents and information required by the trailer dispatch procedure. If multiple trailers are included in the convoy, the trailers may be organized for departure.

Next, in layer six business security personnel determine if the trailer passes inspection (step 1106). If the trailer does not pass inspection the trailer is not allowed to leave, business logistics personnel are notified, and business security personnel update the trailer database (step 1108).

If the trailer passes the inspection of step 1106, business security personnel update the trailer database and authorize departure (step 1110). The trailer may be placed in a convoy for departure. In another example, the trailer may be shipped independently. All of the information is reviewed before the trailer is allowed to leave. Additionally, business security personnel may use global positioning system information to track the progress of the convoy. The global positioning system information is recorded by business security because carriers may use different systems and equipment. In addition, each convoy may be escorted by a private security escort.

Once the trailer has departed, in layer seven business security personnel monitor the convoy using a global positioning system and position confirmation from an escort (step 1112). The escort checks in with the business security personnel at regular intervals. For example, the escort may use a cell phone to verify the convoy's location every hour. The data reported by the escort is compared against the global positioning system data to verify that the convoy is proceeding as requested without any discrepancies.

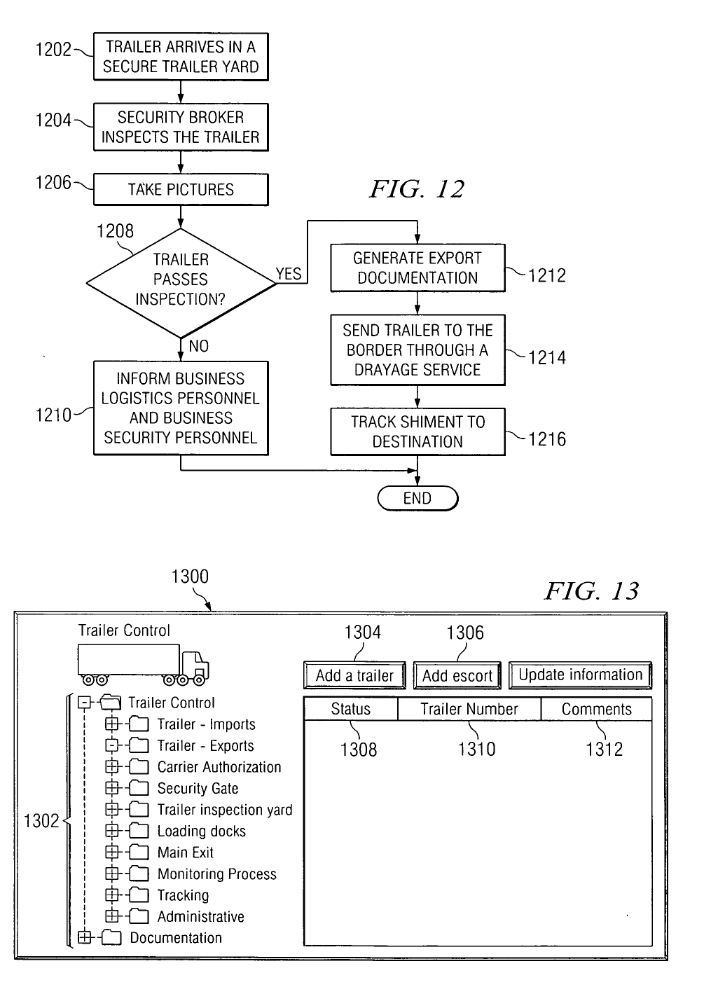

FIG. 12 is a flowchart of a process for an eighth layer of a layered security system in accordance with an illustrative embodiment of the present invention. The process depicted in FIG. 12 is a more detailed description of step 416 in FIG. 4. The steps of FIG. 12 may be performed by the broker at the secure yard such as location C 306 of FIG. 3.

The trailer arrives at the secure yard (step 1202). The security broker inspects the trailer (step 1204). For example, the security broker physically inspects the trailer and verifies that the seal has not bee violated, trailer number, license plate number, and documentation. The security broker may also verify that the trailer complies with department of transportation standards for the applicable countries through which the trailer will pass. Business security personnel may grant access to portions of the trailer database so that the security broker may access trailer information and tracking information to track and verify trailer information. Before the trailer is passed into the secure yard, the security broker takes photographs of the trailer (step 1206). Digital photographs are taken of the trailer to verify the condition of the trailer before the trailer is taken into the secure yard.

Next, the broker determines if the trailer passes inspection (step 1208). If the trailer does not pass the inspection, the broker informs business logistics personnel and business security personnel (step 1210). The cargo may have been compromised and as a result the business may need to respond with further inspection and/or verification of the trailer and cargo. For example, business logistics personnel user pre-crossing validations to ensure that all documents and requirements are met. If there are problems, business attorneys, executives, logistics, and security personnel may need to collaborate to determine whether or not the trailer should cross the international border.

If the trailer passes inspection in step 1208, the security broker generates export documentation for the border crossing (step 1212). The security broker is also responsible to verify wheels, lights, and mechanical condition of the trailer prior to crossing the international border. The security broker may also take pictures of the trailer which may include pictures of the trailer, seals, license plates, hinges, and a picture of the driver. Once all of the necessary preparations are made, the security broker sends the trailer to the border through a drayage service (step 1214). Business security and the security broker may track the shipment to the destination (step 1216) with the process terminating thereafter.

FIG. 13 is a diagram of a graphical user interface for a layered freight security program in accordance with an illustrative embodiment of the present invention. Embodiments of the present invention may be implemented in a computer program or database for documenting steps within each layer. Window 1300 is an example of a graphical user interface that may be used by a business to monitor a layered security process. Window 1300 may include icons, buttons, lists, drop down menus, and other visual means to enter and view information.

Window 1300 may be used to enter information for a layered security method such as steps 402-416 of FIG. 4. Additionally, window 1300 may be used to review trailer information which may include check lists, documentation, trailer data, and photographs. Section 1302 may be used to select a desired action within the database. For example, the user may elect to enter information regarding imports or exports. The user may also enter and review information, such as, for example, carrier authorization, security gate, trailer inspection yard, loading docks, main exit, monitoring process, tracking and administration.

Window 1300 may also allow a user to add a trailer by manipulating icon 1304. The user may also add escort information using icon 1306. Window 1300 displays status 1308, trailer number 1310, and comments 1312 to quickly review the status and location of a trailer in the layered security process.

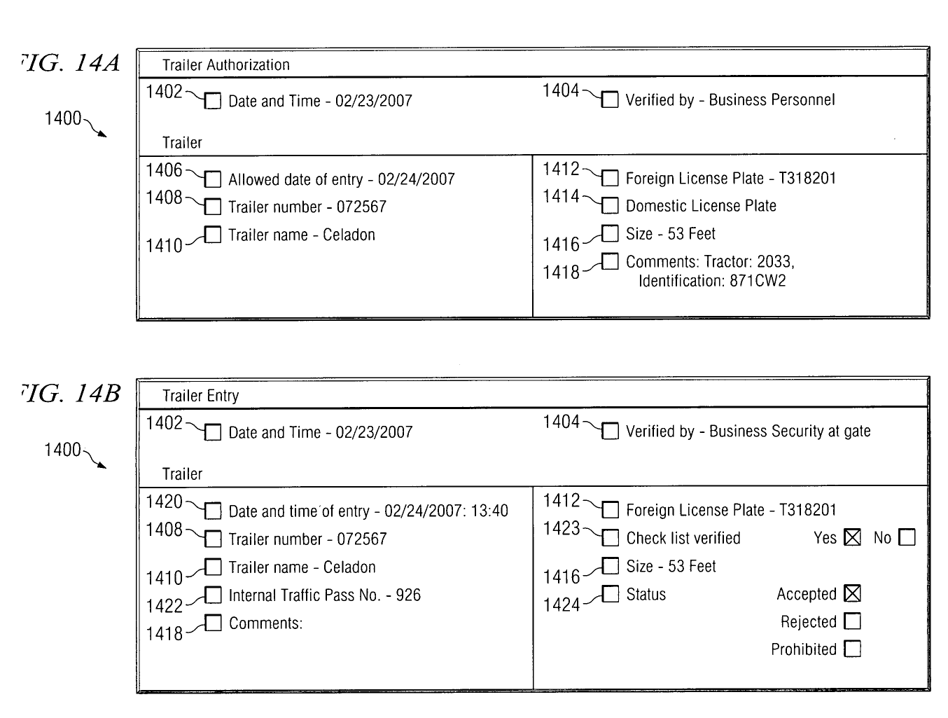

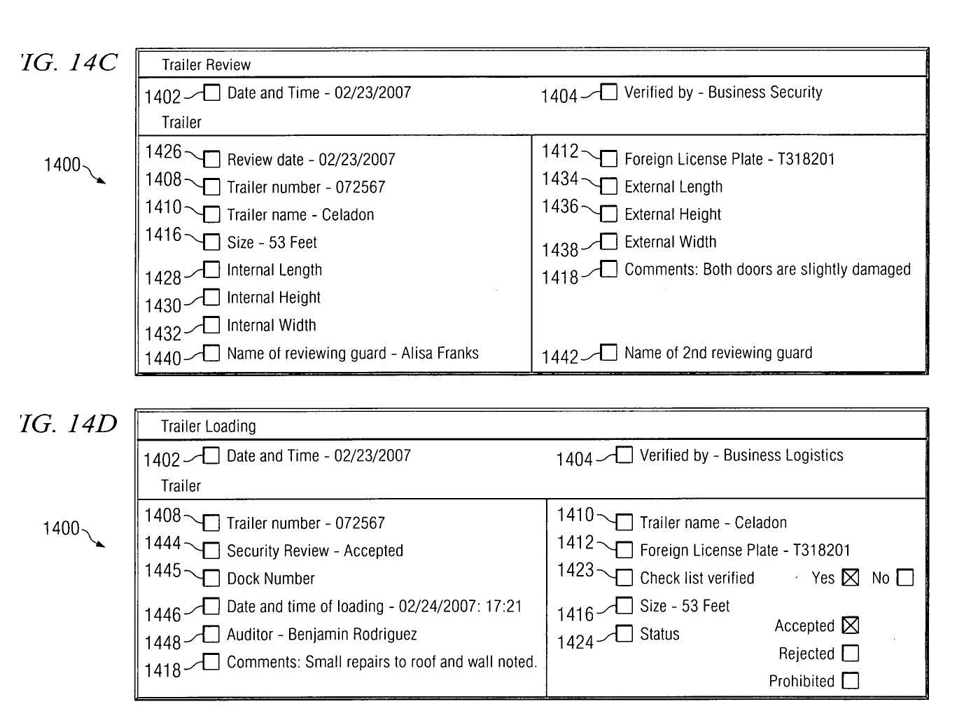

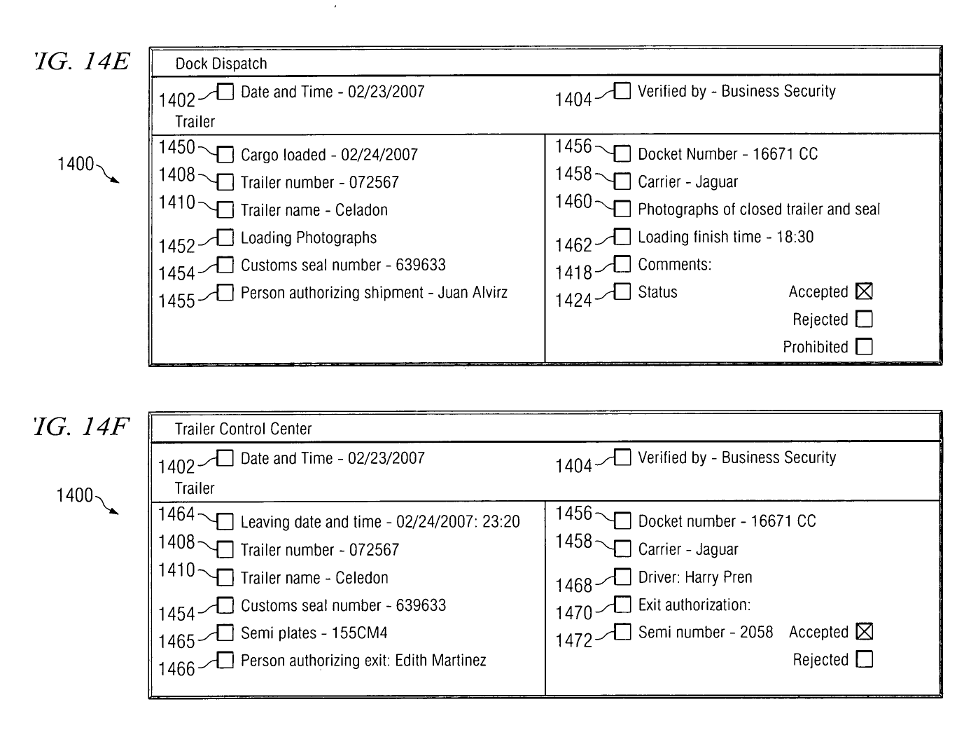

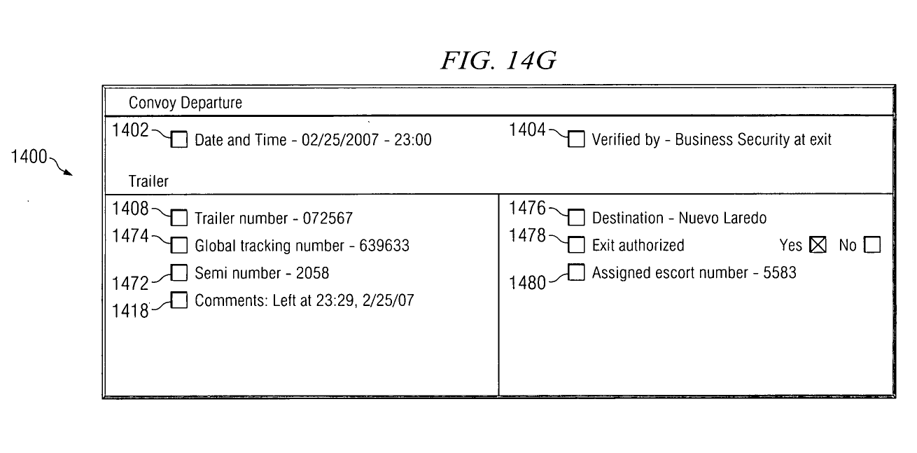

FIGS. 14A-14G are diagrams of a graphical user interface for a trailer database in accordance with an illustrative embodiment of the present invention. Window 1400 is an example of a graphical user interface that may be used to enter and review any number of fields. Window 1400 of FIG. 14A may be used to enter information for trailer authorization received from a carrier such as step 814 of FIG. 8. Window 1400 may display and receive textual information, files such as electronic check lists, photographs, and other data on a computing device such as data processing system 200 of FIG. 2.

The trailer database illustrated in window 1400 may be accessed and displayed through a program or window such as window 1300 of FIG. 13. For example, window 1400 may include date and time 1402, which indicates when the information is entered in the trailer database. Verified by 1404 specifies which party has entered the information into the trailer database. For example, information may be entered by business personnel. This information may include business security personnel and business logistics personnel.

Allowed date of entry 1406 may specify a deadline for the selected trailer to enter the business facility. Trailer number 1408 specifies the trailer number, which is an identification number labeling or imprinted on the trailer. Trailer name 1410 specifies the brand or company name of the trailer. Foreign license plate 1412 is the license plate number of the trailer for the country into which the trailer will be passing. Domestic license plate 1414 is the domestic license plate number for the country from which the trailer is originating. Size 1416 indicates the size of the trailer. Size 1416 may include a drop down menu allowing a user to indicate the size from a list of standard trailer sizes, such as forty eight and fifty three feet. Comments 1418 allows a user to enter any additional information that may be useful in the subsequent processing of the trailer.

Window 1400 of FIG. 14B an example of a graphical user interface that may be used by business security personnel in a layered step such as step 902 of FIG. 9 to verify trailer information. In addition to fields previously described, window 1400 may include date and time of entry 1420 indicating when the trailer was allowed to enter the business facility. Internal traffic pass number 1422 indicates the number of the security pass granted to the trailer enabling the trailer to move freely within business facility. Check list verified 1423 specifies that the applicable layer check list or documentation has been verified using the trailer database or other documentation. Status 1424 indicates whether the trailer was accepted, rejected, or prohibited. For example, the trailer may be rejected if trailer number 1408 of the trailer physically present at the business gate is not the same as trailer number 1408 entered in the trailer database.

Window 1400 of FIG. 14C an example of a graphical user interface that may be used by business security for a trailer review before performing a layered step such as step 910 of FIG. 9. Window 1400 may include review date 1426 specifying when the trailer was initially reviewed. Internal length 1428, internal height 1430, internal width 1432, external length 1434, external height 1436, and external width 1438 specify internal and external measurements of the trailer that may be verified by business security personnel. Any discrepancies may indicate that the trailer has been modified or altered and is unsuitable to transport freight. Window 1400 may also include fields for name of reviewing guard 1440 and name of second reviewing guard 1442.

Window 1400 of FIG. 14D an example of a graphical user interface that may be used by business logistics personnel before cargo loading in a step such as step 1008 of FIG. 10. Security review 1444 specifies that the security review has been accepted. Dock number 1445 indicates a number designation for the location in which the trailer was loaded. Date and time of loading 1446 specifies when the cargo was loaded. Auditor 1448 lists the person that performed the audit of the trailer and cargo. Window 1400 may also require business logistics personnel to verify the internal measurements are re-measure the inside of the trailer.

Window 1400 of FIG. 14E an example of a graphical user interface that may be used by business logistics personnel for dispatching the trailer from the loading dock in a layered step such as step 1016 of FIG. 10. Cargo loaded 1450 specifies when the cargo was loaded. Loading photographs 1452 may allow a user to upload or download photographs taken during loading of the cargo or verify if photographs have been uploaded. Customs seal number 1454 is the number of the seal placed on the cargo after loading. Person authorizing shipment 1455 specifies who authorized the trailer to leave the loading dock. Docket number 1456 specifies the number associated with the trailer transaction. Carrier 1458 specifies the name of the carrier that transports the trailer to the broker. Photographs of closed trailer and seal 1460 shows pictures of the trailer and seal after being loaded. Loading finish time 1462 specifies when the loading is completed.

Window 1400 of FIG. 14F is an example of a graphical user interface that may be used by business logistics personnel and business security personnel in a layered step such as step 1104 of FIG. 11 to verify trailer information. Leaving date and time 1464 specifies when the trailer leaves the business facility. Semi plates 1465 indicates the license plate number of the truck or semi to which the trailer is attached. Person authorizing exit 1466 specifies who authorized the trailer or convoy to exit the business facility. Driver 1468 indicates the person driving the trailer. Exit authorization 1470 indicates whether the trailer was authorized to leave or if that authorization was rejected. Semi number 1472 indicates an identifying number of the semi or truck. Semi number 1472 may be a vehicle identification number, serial number, or visible number that may be used to identify the semi-truck.

Window 1400 of FIG. 14G is an example of a graphical user interface that may be used by business security personnel in a layered step such as step 1110 of FIG. 11 to authorize trailer departure. Global tracking number 1474 is a number or identification that may be used to track the trailer as it is transported. Global tracking number 1474 may be provided by any number of global positioning system information providers. Destination 1476 indicates the destination of the trailer or convoy. Exit authorized 1478 indicates whether the trailer was authorized for departure from the business facility as a final check. Assigned escort number 1480 indicates an identification number for the escort that accompanies the convoy to ensure that the freight arrives safely at the secure yard.

Aspects of the present invention provide a method, apparatus, and computer usable program code for layered security of freight. This layered system provides a standard process for preparing a trailer to ship cargo. Multiple inspection and measurement steps ensure that the trailer is only used for the intended purpose of transporting cargo. Additionally, a trailer database, check lists, seals, and photographs are used to ensure the integrity of the trailer as the trailer is moved from the carrier site, business facility, and secure yard. Responsibility for measurements and verification are allocated to the carrier, business security personnel, business logistics personnel and security broker using a computer program and/or trailer database. As a result, the business may efficiently and securely manage mobile containers as they are prepared, loaded, and used to transport cargo across an international border. In examples referenced herein, the mobile container is a semi-trailer or trailer loaded with freight. In other examples, the mobile container may be a crate, liquid container, freight container, semi-trailer, or other receptacle for storing and transporting freight that may be loaded onto a semi-trailer, train, boat, airplane or other transportation device.

The different aspects of present invention can take the form of an entirely hardware embodiment, an entirely software embodiment or an embodiment containing both hardware and software elements. Some steps may even be user implemented steps. In a preferred embodiment, different aspects of the invention are implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for layered security of freight, the method comprising:
responsive to receiving a mobile container from a carrier, verifying information for the mobile container within a database before allowing the mobile container into a facility;
responsive to verifying the information for the mobile container, performing a thorough inspection of the mobile container in the facility;
responsive to performing the thorough inspection, verifying the thorough inspection and loading the mobile container with freight;
responsive to loading the mobile container, authorizing the mobile container to leave the facility; and
tracking the mobile container as the mobile container is transported to a destination.

2. The method of claim 1, further comprising:
inspecting a mobile container at a carrier site by the carrier to determine the information;
submitting the information for entry in the mobile container database; and
sending the mobile container to the facility.

3. The method of claim 1, wherein the verifying for the mobile container step further comprises:
verifying that the information complies with a layer one check list; and
responsive to verifying the information, granting an internal traffic pass.

4. The method of claim 1, wherein the thorough inspection further comprises:
verifying a first seal placed on a door of the mobile container;
measuring internal measurements and external measurements of the mobile container;
inspecting structural integrity of the mobile container;
inspecting functional integrity of the mobile container;
sealing the mobile container with a second seal;
completing a layer three check list; and
updating the information within the mobile container database.

5. The method of claim 4, wherein updating the mobile container information step further comprises:
entering the mobile container information from the layer three check list; and
recording an identification number of the second seal, the structural integrity, the functional integrity, internal measurements, and external measurements.

6. The method of claim 1, further comprising:
responsive to loading the mobile container, sealing the mobile container with a third seal;
completing a layer four check list, photographing the mobile container as sealed with the third seal; and
updating the mobile container information within the mobile container database.

7. The method of claim 1, wherein the authorizing step further comprises:
verifying that the mobile container corresponds to the mobile container information within the mobile container database; and
responsive to authorizing the mobile container to leave, updating the mobile container information within the mobile container database.

8. The method of claim 1, wherein the tracking step further comprises:
monitoring global positioning system information indicating a position of the mobile container; and
confirming the position with a security escort accompanying the mobile container.

9. The method of claim 1, wherein the destination is a security yard and further comprises:
receiving the mobile container at a secure yard by a security broker;
inspecting the mobile container and verifying the mobile container information;
photographing the mobile container to verify a condition of the mobile container;
generating export documentation; and
sending the mobile container to a final destination.

10. The method of claim 1, further comprising updating the mobile container database before and after performing the verifying information for the mobile container step, performing step, verifying and loading step, authorizing step, and tracking step.

11. The method of claim 1, wherein the destination is at least one of a secure yard, airport, shipping dock, and train depot.

12. The method of claim 1, wherein the mobile container is a trailer.

13. A system comprising:
a server;
a storage operably connected to the server wherein the storage includes a mobile container database; and
a client operably connected to the server wherein the client is used to verify mobile container information within a mobile container database before generating an entry indicator allowing the mobile container into a facility, receive results of a thorough inspection of the mobile container in the facility in response to the thorough inspection of the mobile container in the facility, generate a load indicator for authorizing freight to be loaded on the mobile container in response to receiving results that the through inspection has be been passed, generate an exit indicator to authorize the mobile container to leave the facility, and track the mobile container.

14. The system of claim 13, comprising a wireless access link operably connected to the server for updating the mobile container information in the mobile container database using the client.

15. The system of claim 14, wherein the client is a mobile computing device equipped with a wireless network adapter for communicating with the wireless access link.

16. The system of claim 13, wherein the mobile container is at least one of crate, cargo box, liquid container, freight container, and a semi-trailer.

17. A computer program product comprising a computer usable medium including computer usable program code for layered security of freight, said computer program product including:
computer usable program code, responsive to verifying information entered about a mobile container with a database, for generating an entry indicator allowing the mobile container into a facility;
computer usable program code, responsive to generating the entry indicator, for receiving results of a thorough inspection of the mobile container in the facility;
computer usable program code, responsive to receiving results that a thorough inspection has been passed, for generating a load indicator for authorizing freight to be loaded in the mobile container;
computer usable program code for generating an exit indicator authorizing the mobile container to leave the facility; and
computer usable program code for tracking the mobile container as the mobile container is transported to a destination.

18. The computer program product of claim 17, further comprising:
updating information about the mobile container in the database.

19. The computer program product of claim 18, further comprising:
computer usable program code for storing the information about the mobile container in the database before and after performing the computer usable program code for generating an entry indicator, computer usable program code for receiving results, computer usable program code for generating a load indicator, computer usable program code for generating an exit indicator, and computer usable program code for tracking.

20. The computer program product of claim 18, wherein the information includes information from a plurality of check lists and photographs.
